(19) United States
(12) Patent Application Publication
(10) Pub. No.: US 2014/0254173 A1
(43) Pub. Date: Sep. 11, 2014

(54) Dynamic Light Effect Projecting Device

(71) Applicant: Nicholas Jackson, Oak Forest, IL (US)

(72) Inventor: Nicholas Jackson, Oak Forest, IL (US)

(21) Appl. No.: 13/784,988

(22) Filed: Mar. 5, 2013

(51) Int. Cl. F21V 14/00

(52) U.S. Cl. CPC F21V 14/00
USPC 362/311.13; 362/362

(57) ABSTRACT

Light projected through a plurality of nested housings each containing elongated light transmissive openings that are intersecting along their lengths only allows the projected light to exit the device at the points where the light transmissive openings intersect. When relative rotational motion is set forth between the nested housings the intersecting points move with respect to the design of the elongated light transmissive openings and also by which housing(s) are rotated and by the speed of rotation. This allows for radial movement, axial movement and any combination of radial and axial movement of projected light points when viewed in an installation environment.

This non-provisional patent claims reference to the provisional application No. 61/637,350, entitled “Dynamic Light Effect Projecting Device”, filed on Apr. 24, 2012.

### FIELD OF THE INVENTION

The present invention relates to a device capable of projecting static and dynamic light patterns from a centralized location to objects and surfaces surrounding the device in an installation environment for ornamental, seasonal decoration, and mood lighting.

### BACKGROUND OF THE INVENTION

Conventional light pattern projectors, such as constellation projectors also known as ‘starry night projectors’ or ‘starry night sky projectors’ typically only display static light patterns in an installation environment. Prior art does exist for dynamic light displays using such projectors, but only with the projected light patterns revolving around a single axis in the projector mechanism.

Other mechanisms used to project dynamic light patterns onto objects and surfaces in an installation environment use a plurality of mirrors on the exterior of a rotating shape, which is typically spherical, such as the commonly known ‘disco ball’. This type of mechanism uses an external light source and the reflectivity of mirrors to project either static or rotating light points about a single axis of the mirrored shape.

A need is thus considered for a mechanism which can project light patterns onto objects and surfaces in an installation environment wherein the light patterns can be displayed moving radially about an axis in the projector mechanism, moving axially along the rotational axis of the projector mechanism and moving in a pattern that is both radial and axial with respect to the axis of rotation in the projector mechanism.

### SUMMARY OF THE INVENTION

A dynamic light pattern projector mechanism wherein there is a static housing that contains a plurality of light transmissive openings and a secondary dynamic housing which rotates radially with respect to the static housing and also contains a plurality of light transmissive openings. Further, a centralized light source contained inside both housings transmits light through any point wherein the light transmissive openings of the housings overlap. As the dynamic housing rotates, the points where the light transmissive openings of both housings overlap can either move axially with respect to the rotational axis, radially with respect to the rotational axis or in a direction that is both radial and axial with respect to the rotational axis. Light passing through the overlapping portions of the light transmissive openings is thereby projected onto surrounding objects and surfaces in the given installation environment.

### BRIEF DESCRIPTION OF THE DRAWINGS

FIG. 1 is a perspective view of a dynamic housing;

FIG. 2 is a perspective view of a static housing;

FIG. 3 is a perspective view of a dynamic light effect projecting device;

FIG. 4 is an cross-sectional view of the device shown in FIG. 3;

FIG. 5 is a perspective view of an alternate embodiment of a dynamic light effect projecting device.

### DETAILED DESCRIPTION OF THE PREFERRED EMBODIMENTS

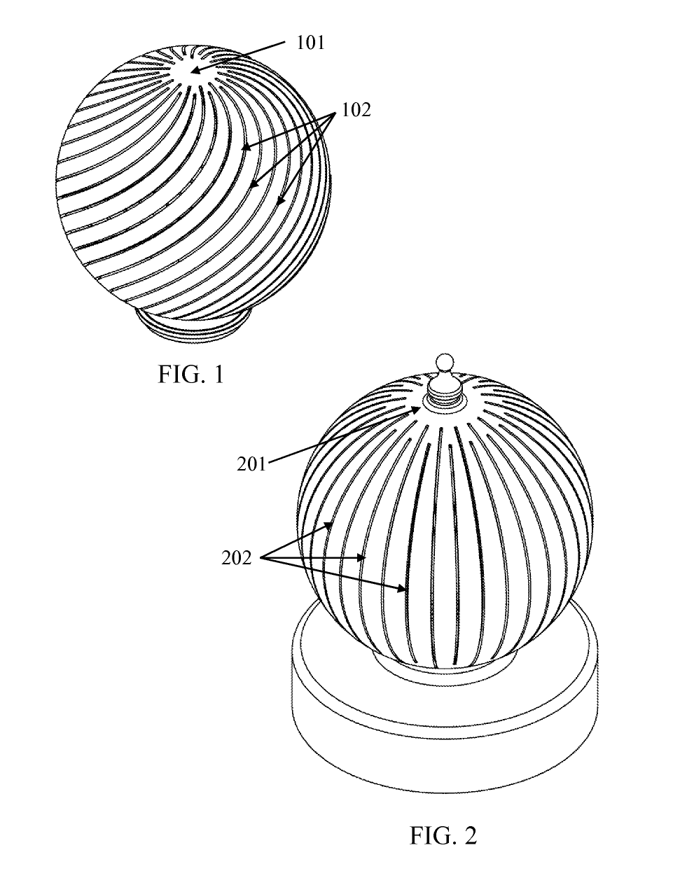

FIG. 1 is a perspective view of a dynamic housing 101. The dynamic housing 101 contains a plurality of light transmissive openings 102 patterned about an axis of the substantially spherical dynamic housing 101. The dynamic housing 101 rotates about an axis when installed into the dynamic light effect projecting device.

FIG. 2 is a perspective view of a static housing 201. The static housing 201 also contains a plurality of light transmissive openings 202 patterned about an axis of the substantially spherical static housing 201. The static housing 201 remains static with respect to the dynamic housings 101 rotation when installed in the dynamic light effect projecting device.

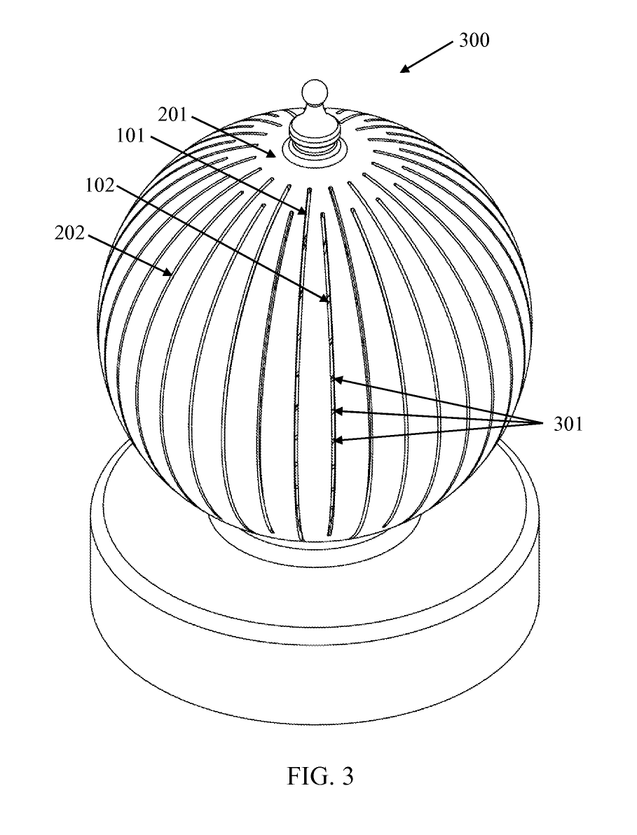

FIG. 3 is a perspective view of a dynamic light effect projecting device 300. The dynamic housing 101 is installed inside the static housing 201. The light transmissive openings 102 and 202 of both housings overlap at multiple points due to their differences in design and curvature. The overlapping points, from now on referred to as light pathways 301, allow light to escape from inside the dynamic light effect projecting device 300. An internally mounted light source, not shown, projects points of light onto objects and surfaces in an installation environment of the device through the light pathways 301. Clockwise rotation of the dynamic housing 101 causes the light pathways 301 to move axially upwards with respect the rotational axis while counterclockwise rotation of the dynamic housing 101 causes the light pathways 301 to move axially downwards with respect to the rotational axis of the dynamic housing 101. The result of the dynamic housing 101 rotation is light points moving upwards or downwards on objects and surfaces in the installation environment of the dynamic light effect projecting device 300.

The dynamic light effect projecting device 300 shown creates the effect of falling snow in an installation environment when the dynamic housing 101 rotates counterclockwise. Modifying the design, direction and curvature of the light transmissive openings can create light pathways 301 that move radially, axially or both with respect to the rotational axis of the dynamic housing 101. Light pathways 301 can also be segmented or randomized on either dynamic or static housings in order to create desired light effects.

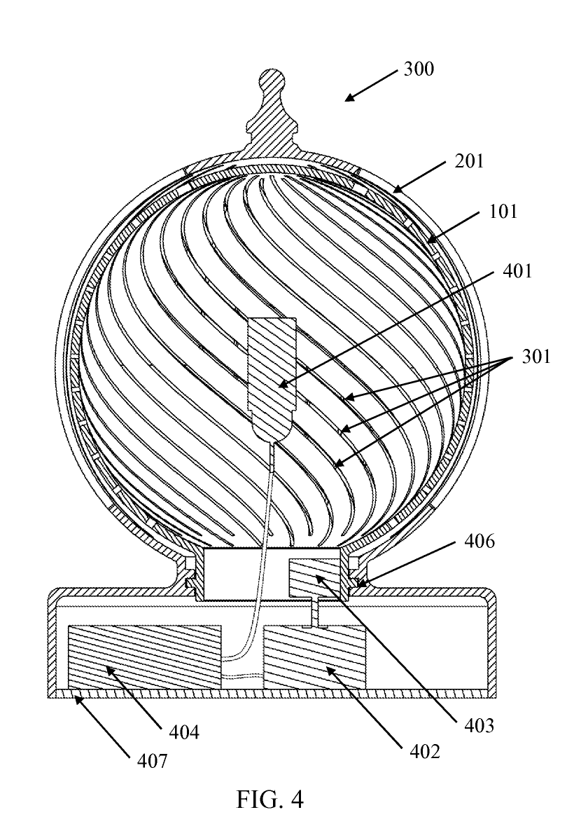

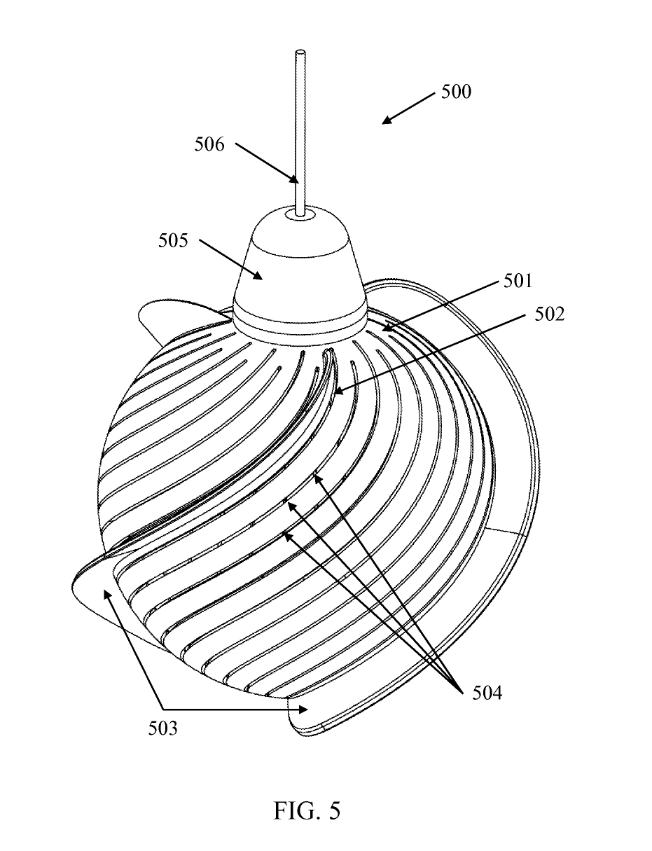

FIG. 4 is a cross-sectional view of the dynamic light effect projecting device 300 shown in FIG. 3. The device requires a centralized light source 401 in order to transmit light into an installation environment through the light pathways 301. The dynamic light housing 101 is captured by features on the static light housing 201 which include a bearing surface 406 allowing for rotation of the dynamic housing 101. An electric motor 402, comprised of a frictional drive wheel 403, is fixed to a base plate 407. The electric motor 402 is frictionally engaged with the dynamic housing 101 and provides the rotation required when the dynamic light effect projecting device 300 is powered on.

Both the electric motor 402 and light source 401 are connected to an electronic controller 404. Power supply circuitry is well known to those of ordinary skill and is therefore omitted for brevity. The device could be powered by an integrated source such as batteries or have electrical considerations allowing for connection to a standard available power grid such as a wall outlet. The electronic controller 404 could also contain circuitry to allow for sequencing of the light source and variable speed control of the drive motor.

FIG. 5 is a perspective view of an alternate embodiment of a dynamic light effect projecting device 500. In this embodiment, the dynamic housing 501 is outside of the static housing 502. Both static and dynamic housings 501 and 502 are operatively coupled to a cap housing 505. The cap housing 505 has internal features allowing for fixed attachment of the static housing 502 and attachment of the dynamic housing 501 wherein rotation is allowed.

Light pathways 504 allow light to be transmitted from inside the dynamic light effect projecting device 500 from a centralized light source, not shown.

The dynamic housing 501 comprises several vanes 503 meant to harness wind energy for rotation of the dynamic housing 501. This embodiment is preferred for outdoor installations and projects light patterns to any objects and surfaces within range of the light projected. A hanging wire 506 allows for display hanging from an available support structure. The hanging wire 506 can serve as a power input if the dynamic light effect projecting device uses external power. Integrated power, such as batteries, can be also be used.

The static and dynamic housings are preferably embodied as at least partially opaque material wherein the light transmissive openings are physical openings allowing for transmission of light. The static and dynamic housings could alternately be made of substantially light transmissive material wherein the at least partially opaque portions are applied by use of paint, printing and masking procedures. The housings are preferably made in sections to allow for ease of assembly during manufacture.

There is no design requirement for two housings with one dynamic housing allowing for rotational movement. The dynamic light effect projecting device only requires relative rotational motion between two or more housings containing light transmissive openings. A plurality, two or more, housings containing light transmissive openings can be configured by which any or all of the housings are made to rotate with respect to each other. The resulting light pattern in a given installation environment will change based on the design selected.

The centralized light source is preferably one or more high intensity LEDs (light emitting diodes) due to the low power consumption and long service life of LED components, however, any available light source can be used in the device. Larger scale installation requirements will likely require high power, higher intensity light sources.

The nested housings, dynamic and static, can also be of any shape allowing for relative rotational movement between them. Preferably, the housings will be substantially spherical or cylindrical to allow for uniform light projection.

As stated above the housings, both dynamic and static, are nested. As used herein, the term “nested” should be construed to mean that at least some of one of the housings encompasses or overlaps another.

The foregoing description is for purposes of illustration. The true scope of the invention is set forth in the following claims.

What is claimed is:

1. A light effect projecting device, the device comprising:
a) at least two nested housings each containing a plurality of light transmissive openings configured in such a way to allow relative rotational motion between the at least two housings; and
b) at least one light source housed within the at least two nested housings capable of projecting light to the outside of the device; and
c) a mechanism capable of rotating at least one of the at least two nested housings.

2. The light effect projecting device of claim 1 wherein the light transmissive openings are physical openings on the nested housings exterior surfaces.

3. The light effect projecting device of claim 1 wherein the nested housings are comprised of at least partially light transmissive material.

4. The light effect projecting device of claim 3 wherein the light transmissive openings are masked or untouched portions of the at least partially light transmissive material which has been printed or painted on.

5. The light effect projecting device of claim 3 wherein the light transmissive openings are the remainder of the exterior nested housings surfaces that have been covered by another at least partially opaque material.

6. The light effect projecting device of claim 3 wherein there are different percentages of light transmittance at different locations on the nested housings as a result of designed painting, printing or covering with materials of different opacity.

7. The light effect projecting device of claim 3 wherein the at least partially light transmissive material is colored.

8. The light effect projecting device of claim 1 wherein the mechanism providing relative rotational motion between nested housings is a motor.

9. The light effect projecting device of claim 1 wherein the mechanism providing relative rotational motion between nested housings is an integrated feature capable of harnessing natural forces such as wind or water flow.

10. The light effect projecting device of claim 1 wherein only one of the nested housings is rotated.

11. The light effect projecting device of claim 1 wherein a plurality of nested housings are rotated.

12. The light effect projecting device of claim 1 wherein the power source for the light source, motor, or both is integrated into the device.

13. The light effect projecting device of claim 1 wherein the power source for the light source, motor, or both is an available power circuit connected by conventional means.

14. The light effect projecting device of claim 1 wherein the nested housings are made in multiple sections to allow for simplified assembly.

15. The light effect projecting device of claim 1 wherein the nested housings are substantially spherical in shape.

16. The light effect projecting device of claim 1 wherein the nested housings are substantially cylindrical in shape.

17. The light effect projecting device of claim 1 wherein the at least one light source is comprised of LEDs.
